(19) United States
(12) Patent Application Publication
(10) Pub. No.: US 2009/0040296 A1
(43) Pub. Date: Feb. 12, 2009

(54) Head mounted display assembly

(76) Inventor: Jonathan D. Moscato, Alden, NY (US)

Correspondence Address: Jonathan D. Moscato, 3460 Wende Road, Alden, NY, 14004, US

(21) Appl. No.: 12/215,496

(22) Filed: Jun. 27, 2008

Related U.S. Application Data
(60) Provisional application No. 60/963,633, filed on Aug. 6, 2007.
(60) Provisional application No. 60/964,232, filed on Aug. 11, 2007.

(51) Int. Cl. H04N 13/04

(52) U.S. Cl. 348/53; 348/E13.001

(57) ABSTRACT

A display assembly comprised of a binocular micro-display attached to a head supported structure such as goggles, helmet, eyewear, or a headband and provides the user with an optical projection in the user's upper line of sight while providing an unobstructed horizontal line of sight of the user's external environment.

### CROSS-REFERENCE TO RELATED APPLICATIONS

This application claims the benefit of provisional patent application for Ser. No. 60/938,378 filed on Jun. 27, 2007 by the present inventor; Ser. No. 60/963,633 filed on Aug. 6, 2007 by the present inventor; Ser. No. 60/964,232 filed on Aug. 11, 2007 by the present inventor.

### FEDERALLY SPONSORED RESEARCH Not Applicable SEQUENCE LISTING OR PROGRAM

Not Applicable

### BACKGROUND OF THE INVENTION

1. Field of the Invention

The present invention relates to a head mounted display assembly, and more particularly, a binocular micro-display mounted to a head supported structure which projects an image in the user's upper line of sight while providing an unobstructed horizontal line of sight of the user's external environment.

2. Prior Art

There are many situations in which it would be useful for a person who is interacting with his outside environment to have the capability to periodically observe a micro-display by simply glancing his eyes to his upper line of sight. Because the user needs to view and interact with his external environment, the micro-display must not obstruct his horizontal and below horizontal lines of sight.

Additionally, the user must be able to see a clear image of the micro-display, so the display must provide a single mental image to the user. Furthermore, the micro-display must be properly aligned to the user's eyes and secured to his head. Optimally, the device should present a clear image in high ambient light conditions.

Generally speaking, monocular micro-displays are theorized to cause a condition called binocular rivalry which is a phenomenon of visual perception in which perception alternates between different images presented to each eye. Monocular micro-displays are also theorized to encourage a condition called consensual pupillary reflex which causes both pupils to constrict when only one eye is exposed to bright light. Both conditions can significantly degrade the perceived image quality of a micro-display.

### BACKGROUND OF THE INVENTION—OBJECTS AND ADVANTAGES

It is therefore an object of the present invention to provide a novel head mounted display assembly devoid of the above noted disadvantages of the prior-art.

It is another object of the present invention to provide a head mounted display assembly which projects an image nominally normal to the user's upper line of sight.

It is also an object of the present invention to create a novel head mounted display assembly which allows a user to easily view and interact with an unobstructed view of his external environment.

It is a further object of the present invention to provide a fixed angular projection of the micro-display allowing the user to easily align the display assembly by quickly donning the display assembly and simply sliding it until the fixed optical projection properly intersects with the user's upper line of sight.

It is still a further object of the present invention to create a novel head mounted display assembly which prevents optical lens surface glare and reflection while the display assembly is exposed to high ambient light conditions.

It is yet another object of the present invention to create a novel head mounted display assembly which provides a user with a steady view of the micro-display relative to his eyes when the user's head and body are moving during physical activity.

It is an additional object of the present invention to allow the user to easily interchange the micro-display between special purpose housings which are mounted to various goggles, eyewear, a helmet, or a head band.

Yet another object of the present invention is to create a novel head mounted display assembly which prevents binocular rivalry.

Another still object of the present invention is to provide a head mounted display assembly which prevents consensual pupillary reflex.

These and additional objects of this invention are accomplished generally speaking by a novel head mounted display assembly consisting of a binocular micro-display mounted to a head supported structure which projects an image in the user's upper line of sight while providing an unobstructed horizontal line of sight of the user's external environment.

### DRAWINGS—FIGURES & TABLES

FIG. 1 illustrates the preferred embodiment which is the goggle version of the head mounted display assembly.

FIG. 2A illustrates a front view of the preferred embodiment with the user's eyes positioned in the upper line of sight.

FIG. 2B illustrates a side view of the preferred embodiment with the user's eyes positioned in the upper line of sight.

FIG. 2C illustrates a front view of the preferred embodiment with the user's eyes positioned in the horizontal line of sight.

FIG. 2D illustrates a side view of the preferred embodiment with the user's eyes positioned in the horizontal line of sight.

FIG. 3 illustrates an exploded view of the preferred embodiment.

FIG. 4 illustrates a back view of the preferred embodiment's display housing, showing the housing profile feature.

FIG. 5A illustrates an exploded view of the removable display module embodiment.

FIG. 5B illustrates the removable display module embodiment with the visor housing assembly installed in the modular goggle display and also installed in the modular eyewear display.

FIG. 5C illustrates the removable display module installed in the eyecup housing and also in the freestyle housing.

FIG. 5D illustrates the removable display module mounted in the visor connect housing to create a visor connect assembly.

FIG. 5E illustrates the removable display module inserted into the freestyle, eyecup, or visor connect housing. Each of these housings can be attached to a helmet via a helmet arm.

FIG. 6 illustrates an optional angular adjustment feature used to align the display to the user's upper line of sight.

FIG. 7 illustrates optional lateral clearance flanges.

FIG. 8 illustrates the micro-display mounted in the lower line of sight.

FIG. 9 illustrates the micro-display mounted in the horizontal line of sight.

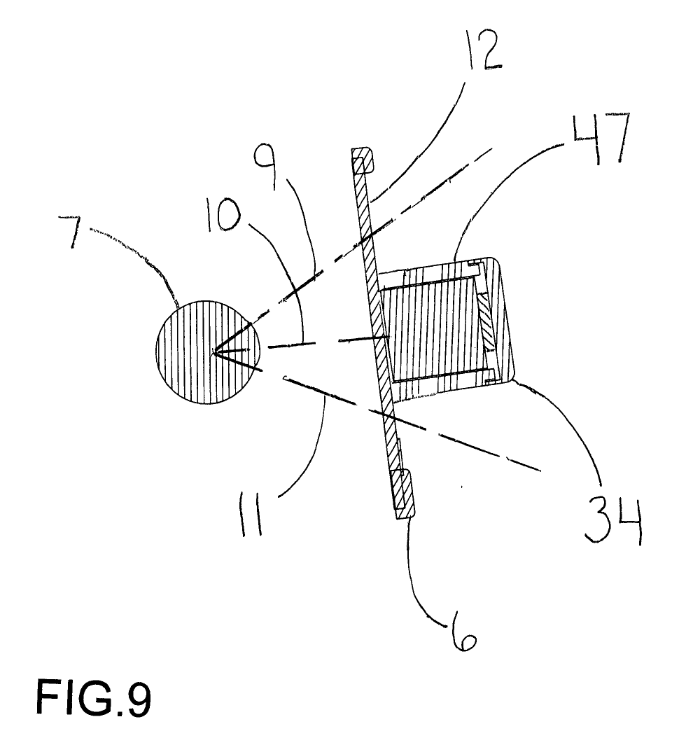

FIG. 10 illustrates the display assembly with the attachment arm repositioned into the actuated position.

FIG. 11 illustrates the level sensor actuation mechanism which moves the micro-display from the user's upper line of sight to an actuated position.

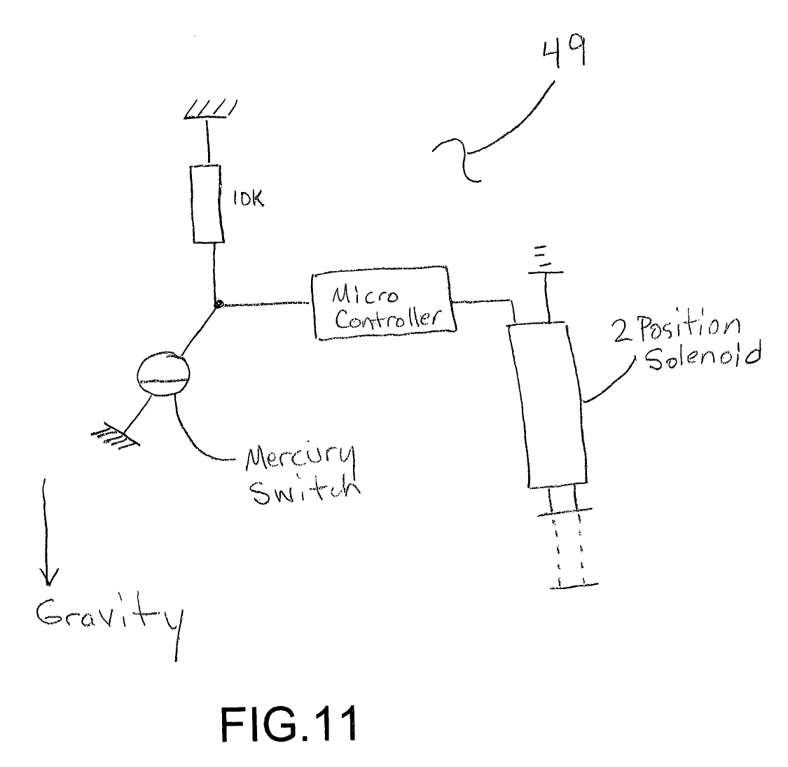

### DRAWINGS—REFERENCE NUMERALS

0 Head Mounted Display Assembly
1 Adjustable Display Housing
3 Viewing Channel
4 Optical Projection
5 Housing Profile Feature
6 Goggle Frame
7 User's Eye(s)
9 Upper Line of Sight
10 Horizontal Line of Sight
11 Below Horizontal Line of Sight
12 Clear Visor
13A Removable Tinted Lens Insert
13A1 Rectangular Lens Cutout
13B Tinted Lens Insert
13A2 Rectangular Lens Cutout
14 Micro-Display
16 Goggles (Head Supported Structure)
17 Spacers
18 Fasteners
19 Cable
20 Tapped Holes
22 Display Housing
23 Midlevel Line of Sight
24 Slots
25 End Cap
26 Bottom Flange
27A Top Angular Gap
27B Bottom Angular Gap
28 Set Screw
29 Spring
33A Lateral Clearance Flange
33B Lateral Clearance Flange
34 Removable Display Module
35 Visor Housing
36 Visor Housing Assembly
37 Modular Goggle Display
38 Modular Eyewear Display
39 Freestyle Housing
40 Eyecup Housing
41 Visor Connect Housing
42 Visor Connect Assembly
43 Attachment Arm
44 Helmet (Head Supported Structure)
45 Locking Cap
46 Lower Line of Sight Visor Housing
47 Horizontal Line of Sight Visor Housing
48 Micro-Display in Actuated Position (Upper Position)
49 Level Sensor Actuation Mechanism

### SUMMARY OF THE INVENTION

Preferably the present invention is comprised of a binocular micro-display and goggles. A housing is attached to the goggles visor and configured to provide the user with an unobstructed horizontal and below horizontal field of view. The housing is further configured to hold the binocular micro-display so it provides an optical projection nominally normal to the user's upper line of sight.

One aspect of the present invention allows a user who is viewing and interacting with his external environment to simply glance at his upper line of sight to clearly view the a micro-display's optical projection. The invention provides the user with an unobstructed horizontal and below horizontal line of sight of his external environment.

An example of how the present invention can be used is to provide a digital rear view image to a vehicle operator by connecting the display assembly's input signal to a digitally mirrored video camera. The camera is mounted to the rear of a vehicle and facing the road behind the vehicle. In this example, the present invention allows for an unobstructed horizontal and below horizontal view of the road ahead, and the operator need only glance to his upper line of sight to clearly see a live image of his rear view. Typical vehicles may include bicycles, motorcycles, cars, trucks, or military vehicles. The display assembly may also be used to view GPS maps, a computer display, surveillance video, a digital gun sight, or any other output which can be shown on a micro-display.

A second aspect of this invention allows use in direct sunlight. High ambient light conditions can be handled by reducing direct and indirect ambient light, which can cause glare and reflection on the optical surfaces of the micro-display. Indirect light includes light reflected off surfaces near or coincident to the micro-display's optical surfaces. Indirect light may include ambient light which is reflected from the user's eyes and face onto the micro-display surfaces. This is achieved by shrouding the micro-display's optical faces from outside light, and tinting the area between the user's eyes and the outside environment by utilizing removable tinted lenses. Additionally, the micro-display's optical lenses can be shielded with anti-glare film.

Preferably the tinted lenses are removable, so that the user can clearly see his external environment during low ambient light conditions by simply removing the tinted lenses. Preferably the direct ambient light is reduced by employing a shrouded channel (display housing) between the micro-display and visor and a shrouded frame (goggle frame) between the visor and the user's face.

Binocular rivalry and consensual pupillary reflex are both theorized to occur when using a monocular micro-display. In the case of binocular rivalry, perception alternates between the images presented to each eye, degrading the perceived image quality. In the case of consensual pupillary reflex, both of the user's irises will involuntarily contract to the same small diameter. This contraction can diminish the user's perceived image intensity of a monocular micro-display and make the image appear dim.

The tern binocular microdisplay or micro-display is used herein as a micro-display which projects two identical or complimentary images which can be mentally combined by the user into a single mental image. The term binocular micro-display is additionally defined herein as a micro-display which presents a single optical projection into one eye, and a blank or black image into the other eye.

Micro-displays are typically comprised of a small cathode ray tube (CRT), liquid crystal display (LCD), liquid crystal on silicon (LCoS), or organic light-emitting diode (OLED) displays with magnifying lenses. Micro-display optical lenses are typically focused to optical infinity to give the perception that the optical projection is coming from a greater distance, in order to prevent eye strain.

Preferably the head supported structure allows the display to be readjusted on the user's head so the display assembly can be shifted out of the user's upper line of sight when not in use. Eye fatigue is prevented by focusing the micro-display lenses near or at optical infinity, so when the user glances at the display and then glances to his outside environment, he can simply relax his eyes and remain focused at optical infinity to view both the optical projection and his outside environment.

The present invention may optionally provide a removable display module to allow the user to easily insert and lock the micro-display within various special purpose housings which are attached to either goggles, a helmet, eyewear, or a headband.

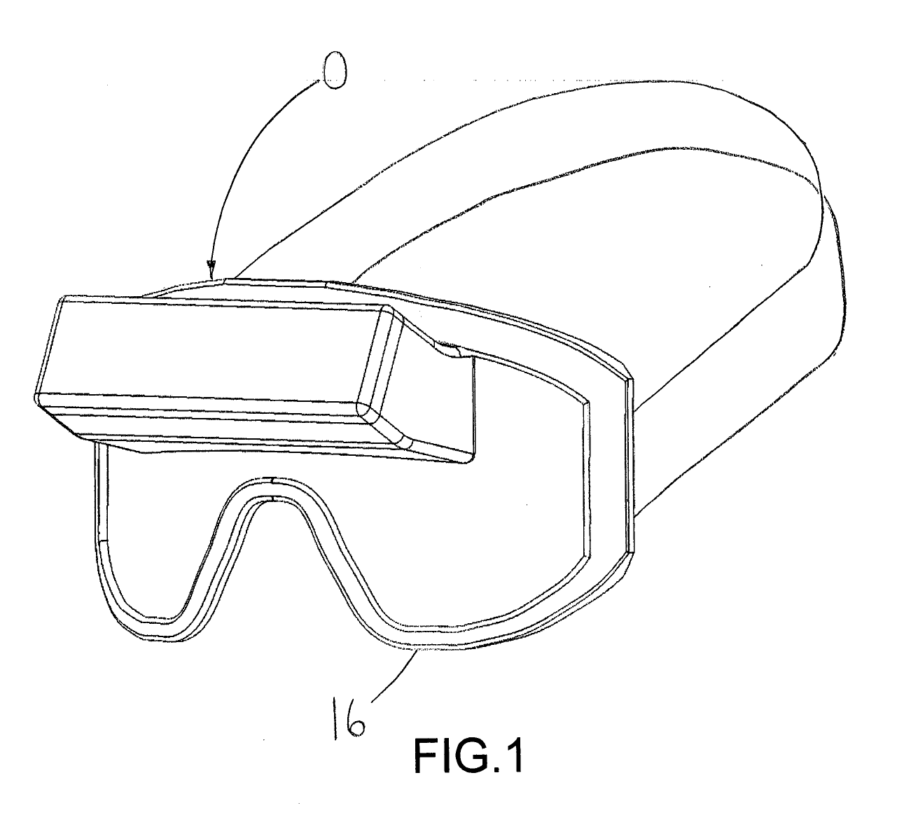

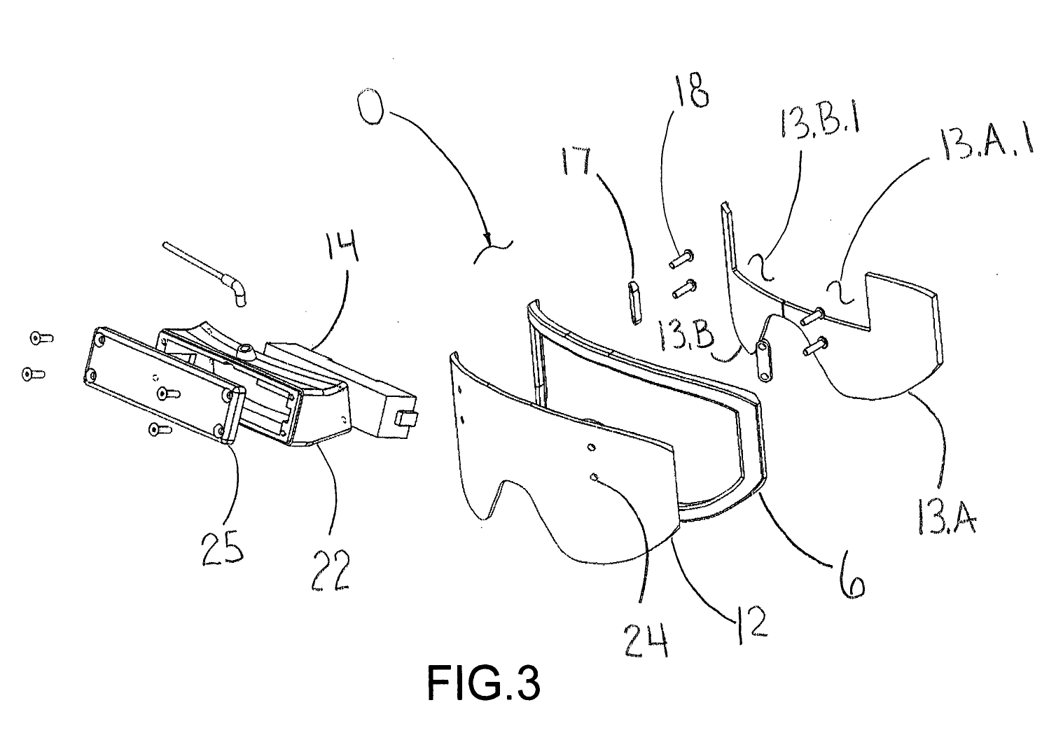

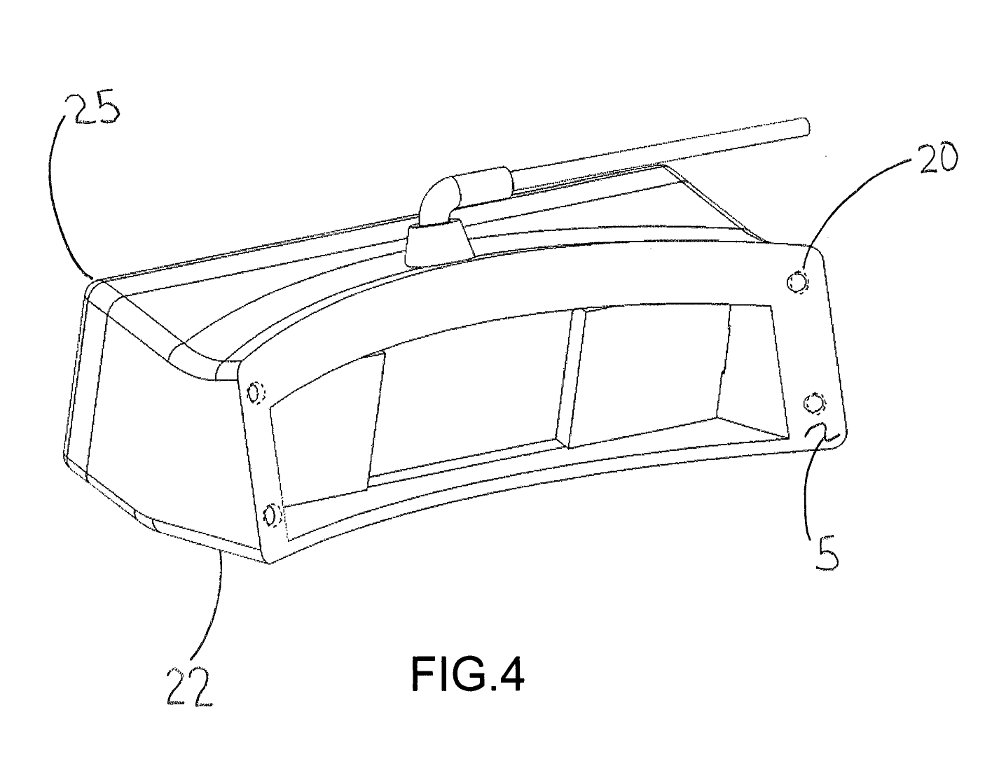

### Detailed Description—FIG. 1-4—the Preferred Embodiment

The preferred embodiment of the present invention consists of head mounted display assembly 0. Display assembly 0 is comprised of micro-display 14 retained with an enclosure consisting of display housing 22 and end cap 25. Display housing 22 is attached to a head supported structure (in this embodiment, goggles 16). Micro-display 14 is manufactured by Kopin, model BDM-230J. Micro-display 14 is a binocular micro-display, QVGA-quality 320 X 240 resolution video optical unit.

Display housing 22 has viewing channel 3 consisting of a hollow rectangular void which allows optical projection 4 to travel from the display to the user's eyes 7. Housing profile feature 5 is a shaped feature located at the end of display housing 22 and which conforms to the outer surface of the goggle's clear visor 12. Tapped holes 20 within interface 5 are used to attach display housing 22 to goggles 16. The attachment is made using fasteners 18, which are placed through holes within spacers 17 and through slots within visor 12, and threaded into tapped holes 20.

Display housing 22 and end cap 25 are manufactured using black polypropylene. The black color acts as a light shroud to block external ambient light from reaching optical surfaces within micro-display 14.

Tinted lenses 13A & B may optionally be used during high ambient light conditions. The lenses can be placed within goggles 16 and positioned against the inside surface of clear visor 12. Lenses 13A & B act to reduce ambient light from reaching the face and eyes of the user. Excessive ambient light reaching the face and eyes of the user can cause reflection and glare upon the optical surfaces of micro-display 14, which would otherwise reduce the image visibility of the micro-display. The lenses have rectangular cutouts 13A1 and 13B1 so that the intensity of optical projection 4 is not reduced.

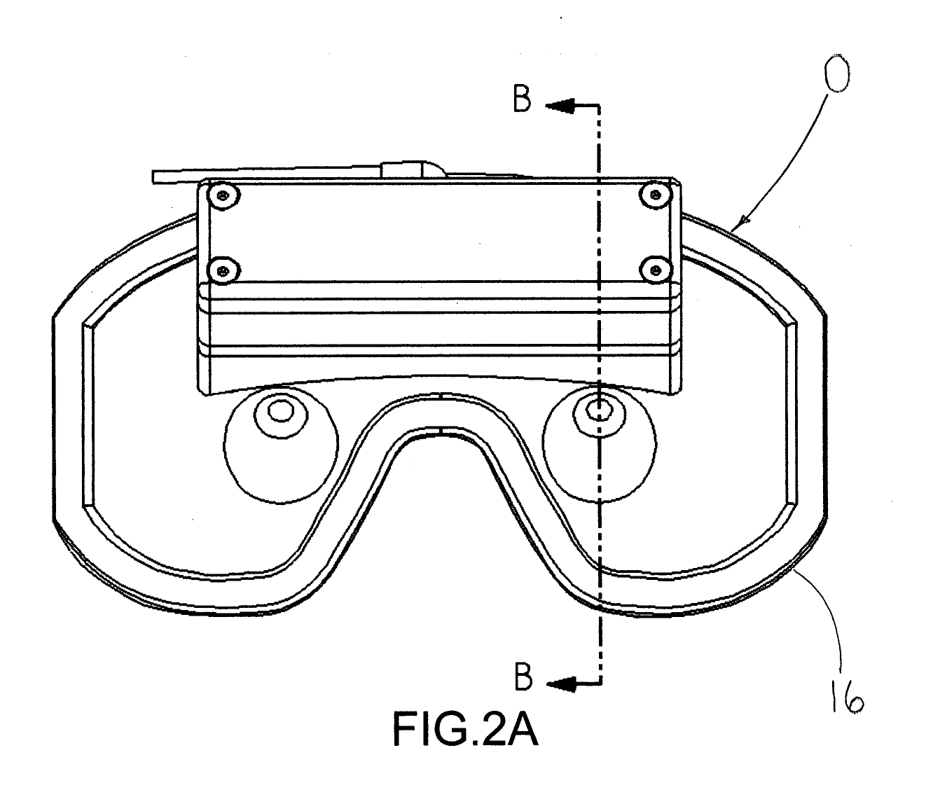

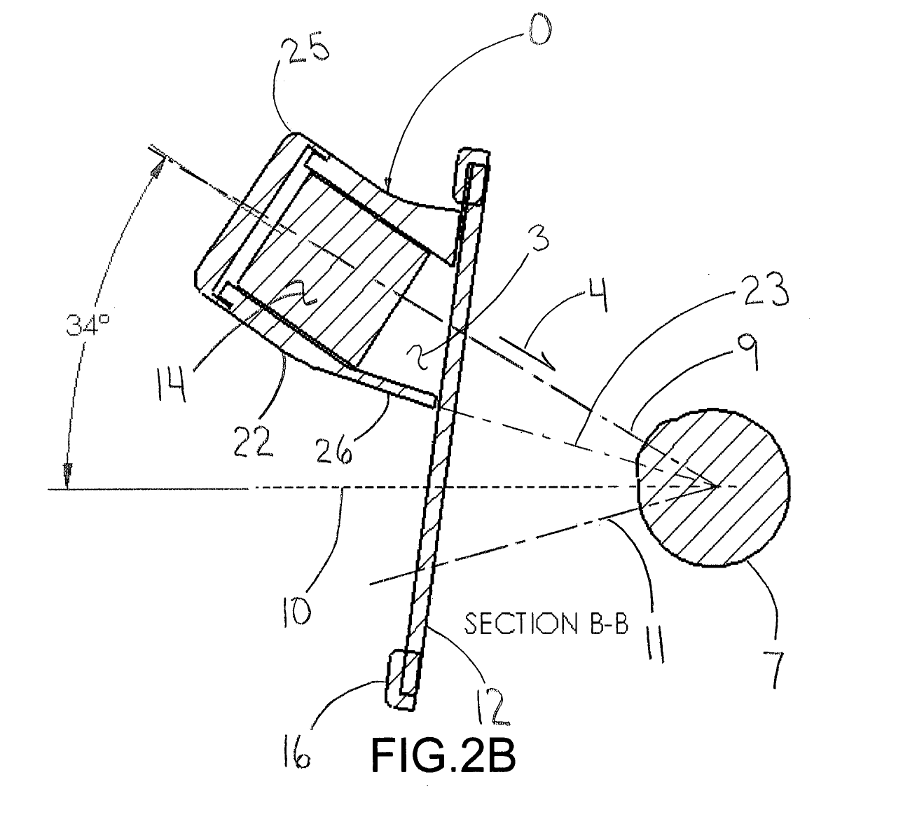

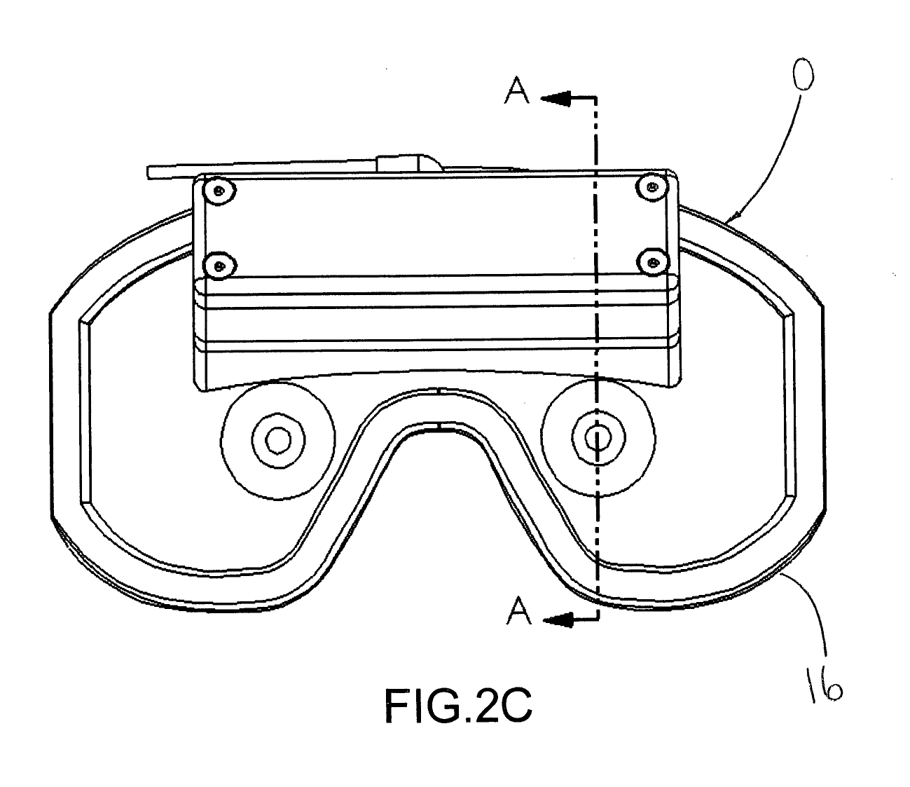

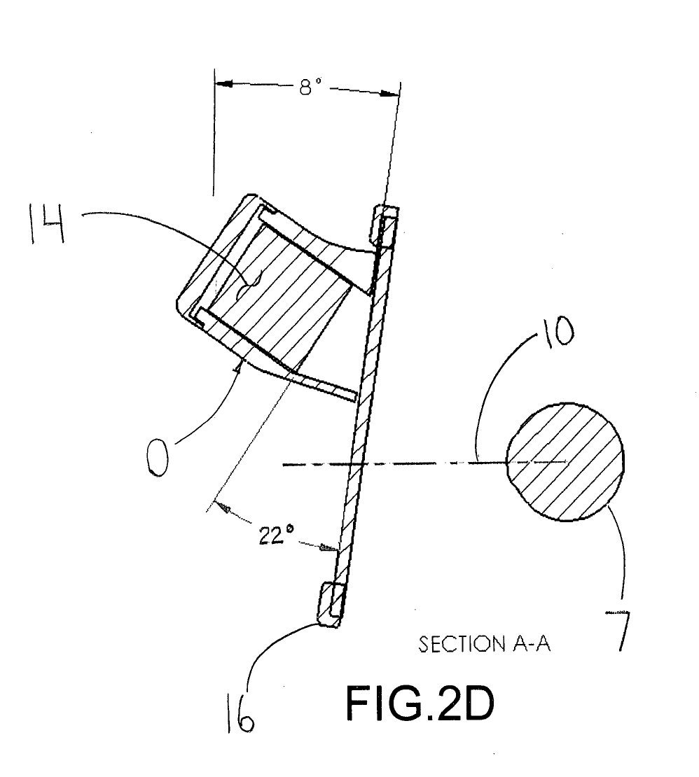

The viewing configuration for the first embodiment is shown within FIG. 2A-D. For this embodiment, goggles 16 are shown tilted approximately 8 degrees from vertical, to represent an approximate natural position of the goggles when worn by a user whose head is in a normal upright position.

The FIGS. 2C & D show an 8 degree tilt, with the user's eyes position in the horizontal line of sight 10. It is shown in FIGS. 2C & D that the user has a sufficient unobstructed view to see and interact with his external environment.

As shown within FIGS. 2C & D, only a small portion of the user's upper peripheral vision is blocked by the display when the user's eyes are positioned in the horizontal line of sight 10. Visibility is further enhanced by the bottom flange 26 on display housing 22. Flange 26 is a feature angled nominally normal to the bottom of the micro-display's optical projection, defined herein as the user's midlevel line of sight 23.

As shown within FIGS. 2A & B, the user need only look up approximately 34 degrees to his upper line of sight 9, in order to view the optical projection emanating from micro-display 14.

The vertical position of display housing 22 may be adjusted by loosening fasteners 18 and sliding the display housing along slots 24, and then retightening the fasteners. Display housing 22 may alternately be attached to visor 12 using adhesive, snaps, or any other means to connect the two mating parts.

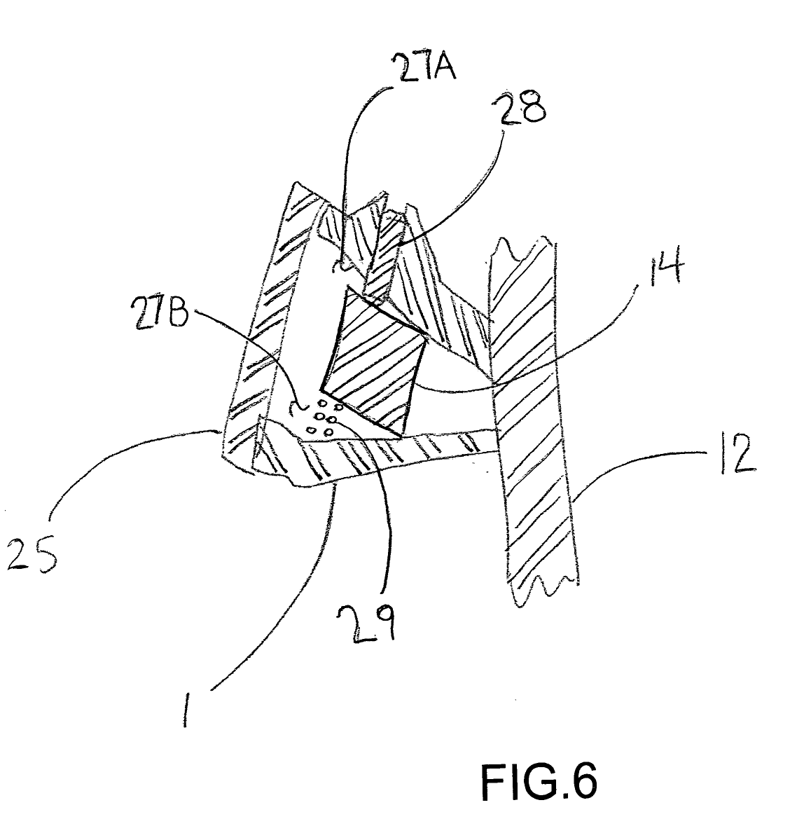

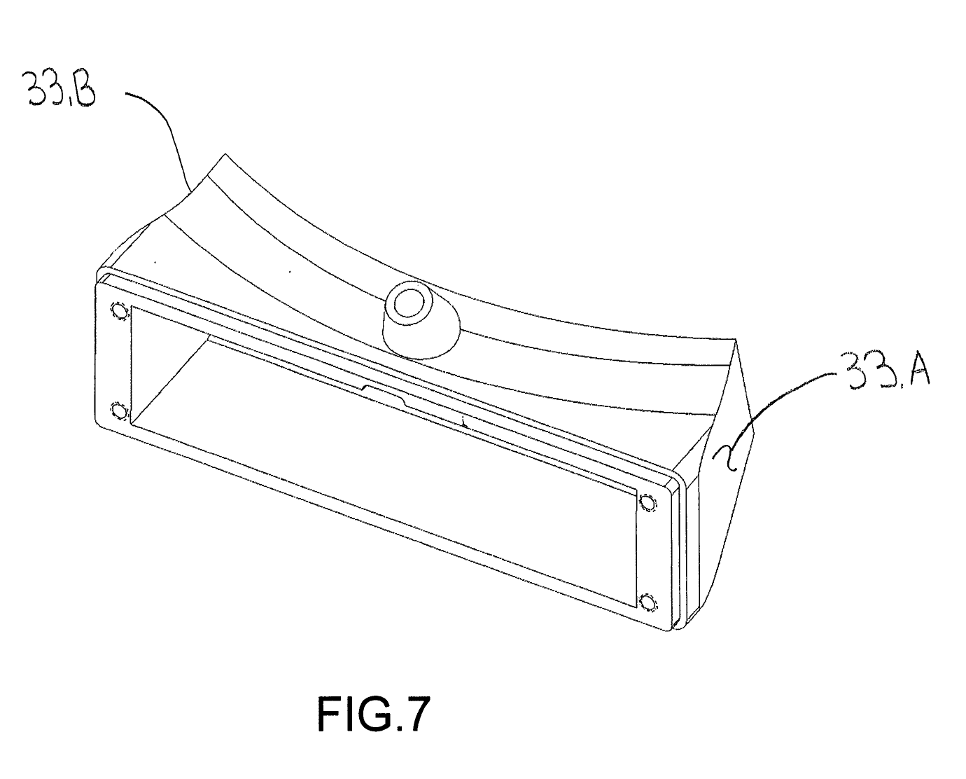

### Additional Options of the Preferred Embodiment—FIG. 6, FIG. 7

The preferred embodiment may optionally have adjustability of the angular alignment of the micro-display (as shown within FIG. 6), in order to ensure that projection 4 is nominally normal to the user's eyes 7 when the user is looking in his upper line of sight 9. This adjustment is achieved by incorporating angular gaps 27A & B within adjustable display housing 1 and placing spring 29 in bottom angular gap 27B and a set screw extending into top angular gap 27A. Adjusting set screw 28 rotates display 14 relative to adjustable display housing 1.

The preferred embodiment may also have lateral clearance flanges 33A & B as shown within FIG. 7. These features are formed by reducing the left and right side profiles to decrease the area obstructed within the upper line of sight. This feature allows the optical projection to appear within the user's upper line of sight with minimal lateral obstruction.

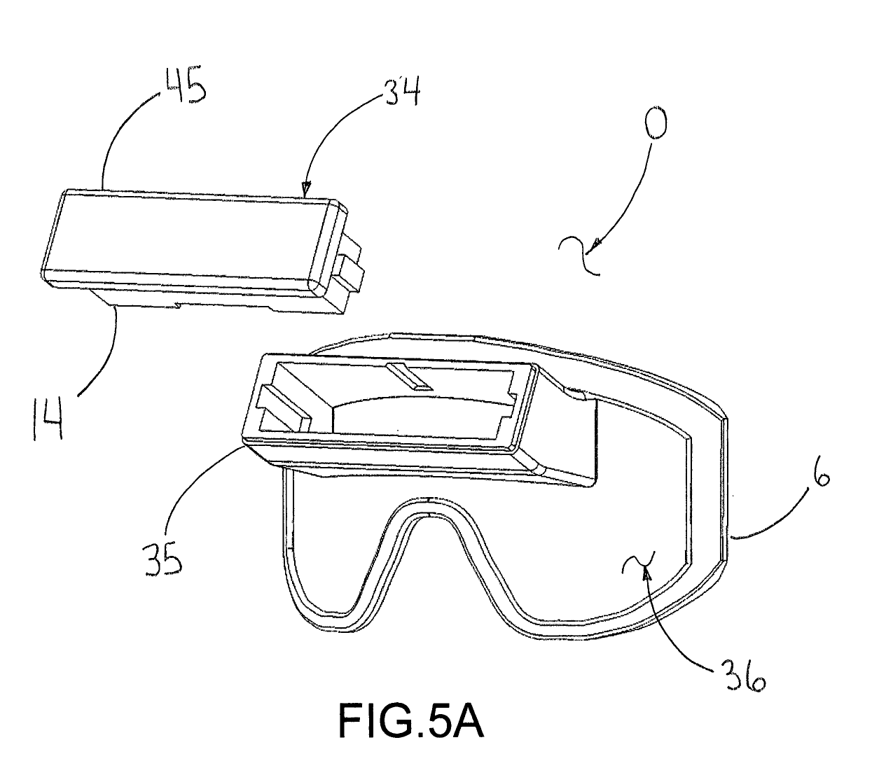

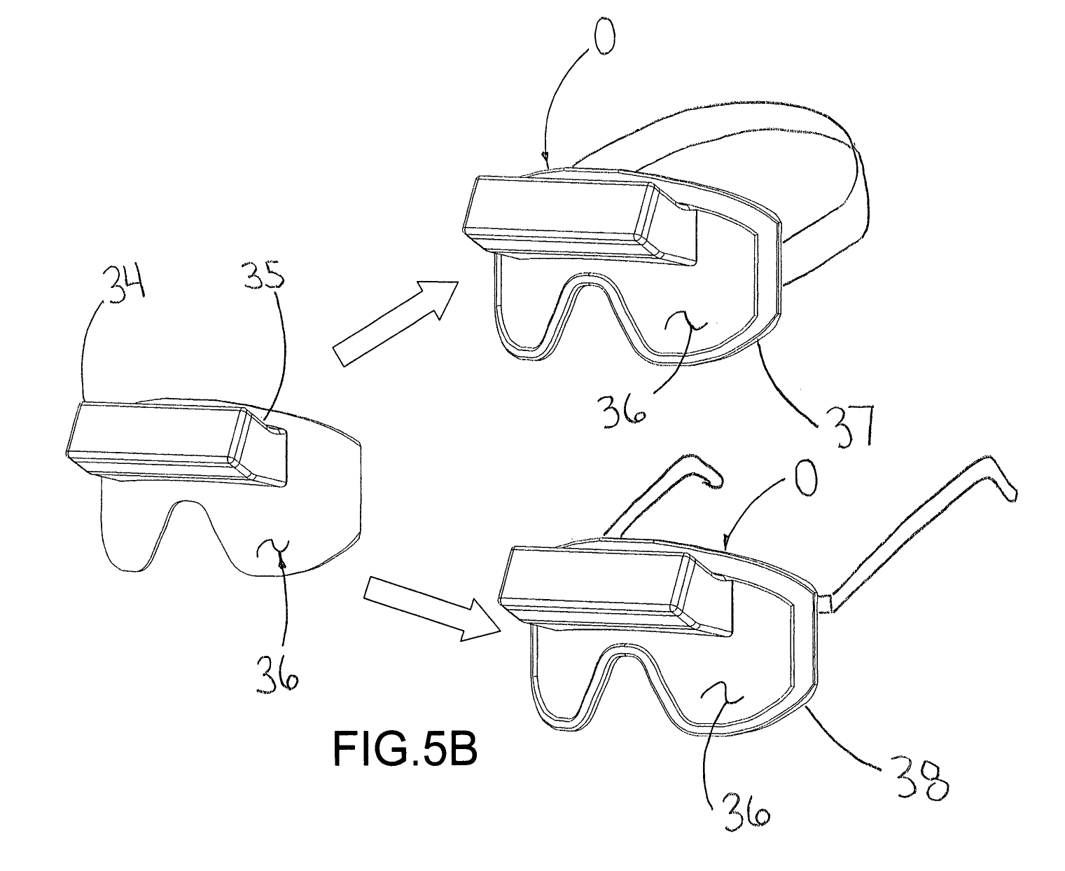

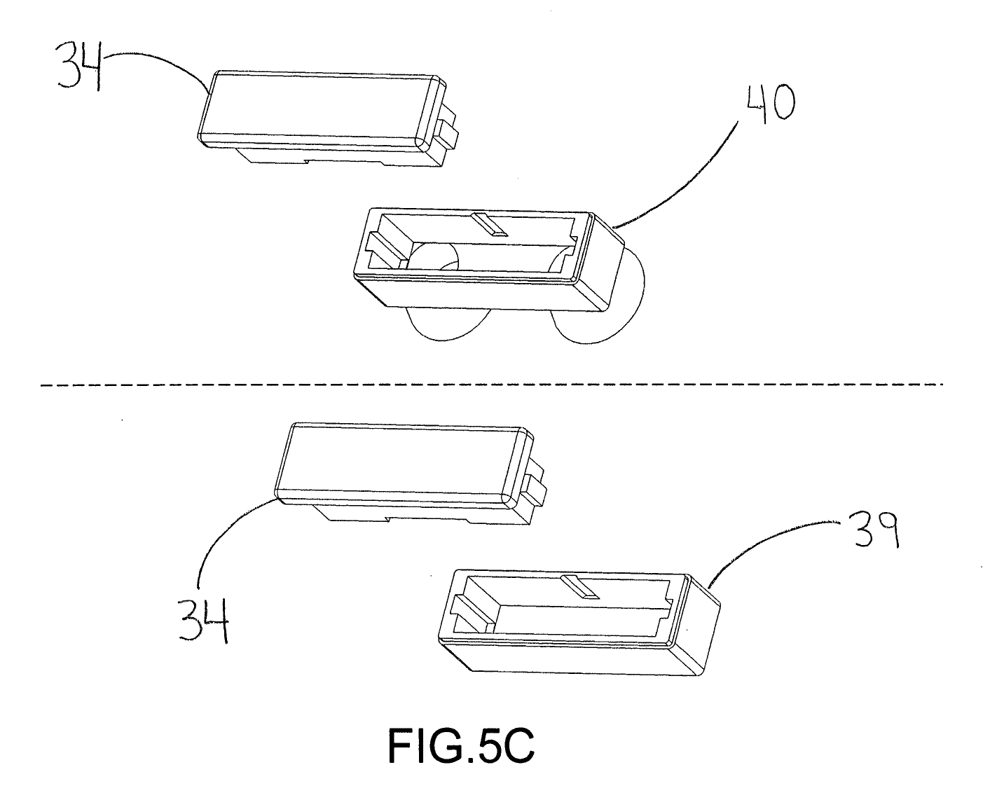

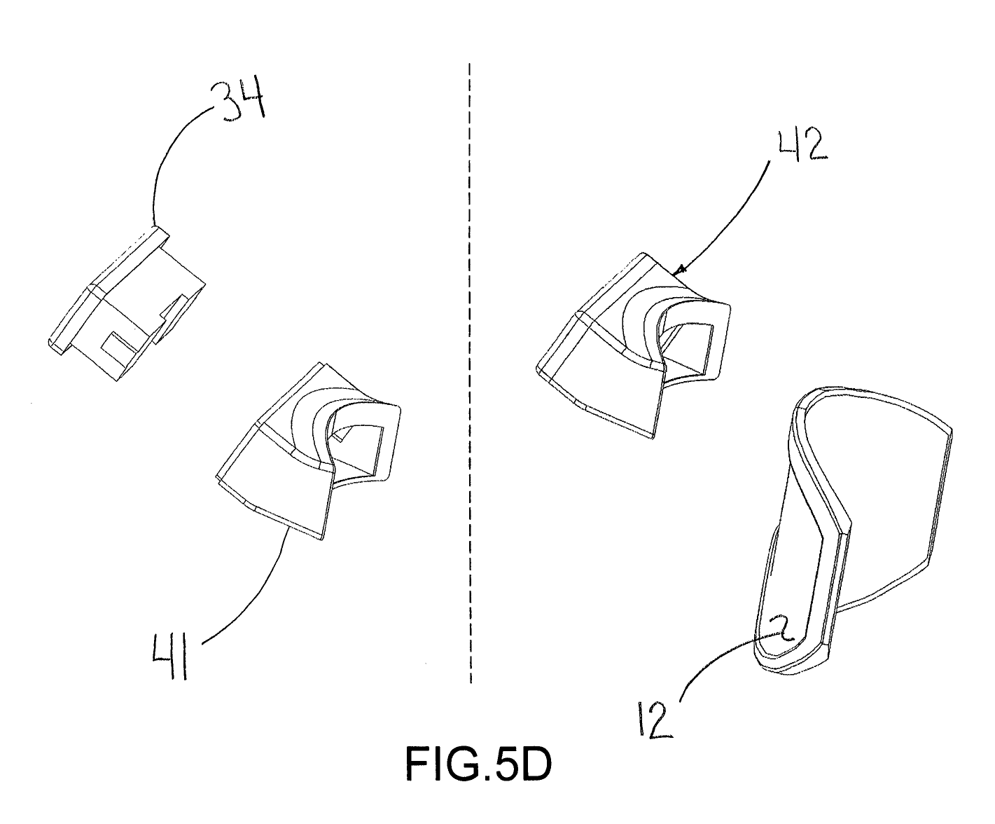

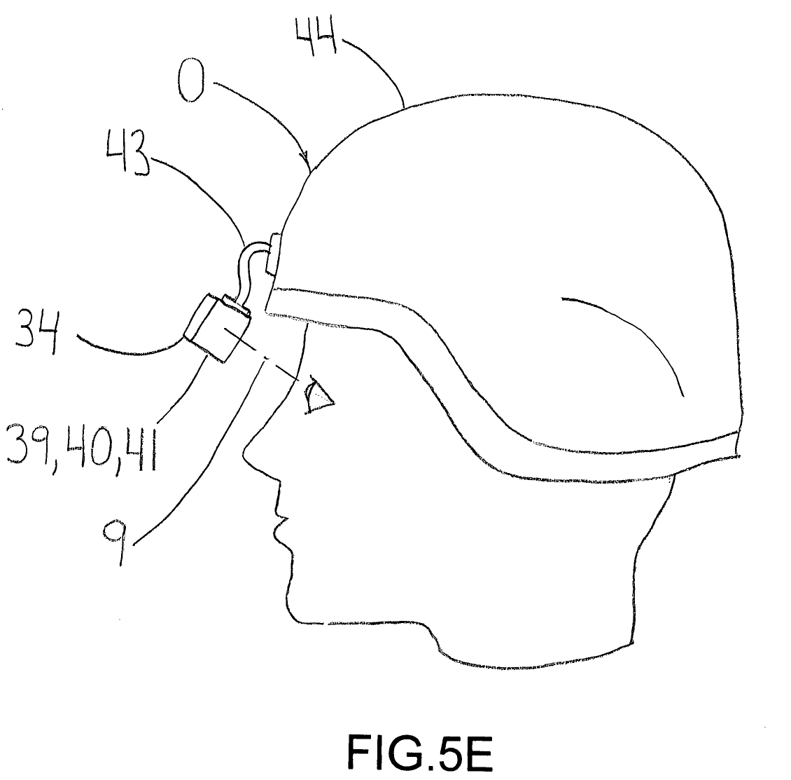

### Removable Display Module Embodiment—FIGS. 5A-E, 8, & 9

As shown in FIGS. 5A-E, 8 & 9 the display assembly can be configured with removable display module 34, which may be used interchangeably with various special purpose housings. The FIG. 5A shows removable display module 34 used with visor housing 35, which is bonded to goggle visor 12 to create visor housing assembly 36.

The FIG. 5B shows visor housing assembly 36 used to form modular goggle display 37 and modular eyewear display 38.

As shown in FIGS. 5C & D, display module 34 can also be inserted into freestyle housing 39, eyecup housing 40, and visor connect housing 41. Housings 39-41 can then be attached to helmet 44 via pivoting or deformable attachment arm 43 as shown in FIG. 5E. Attachment arm 43 allows the display to be rotated or moved out of the user's line of sight when not in use.

The FIG. 5D shows visor connect assembly 42 which is designed to conform to the exterior of visor 12 and be supported by attachment arm 43.

The removable display module 34 is comprised of micro-display 14 and locking cap 45. The removable display module 34 is inserted into custom designed housings 39-41, 46 & 47 and is preferably designed to lock in place via a locking or latching mechanism when fully inserted.

A seal is preferably compressed between the inner lip of locking cap 45 and the outer lip of the visor housing, to create an environmental seal. The removable display module 34 is preferably removed by depressing an unlocking or de-latching mechanism.

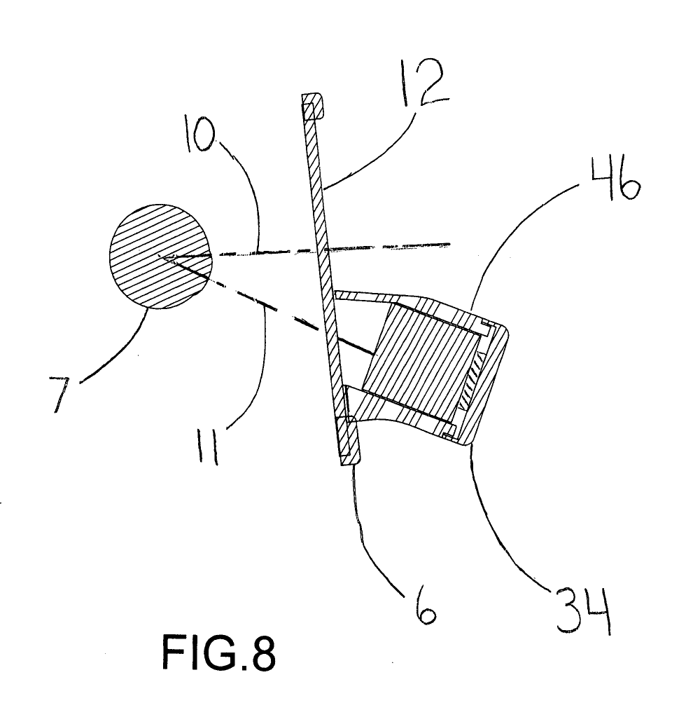

As shown in FIGS. 8 & 9, display module 34 can be inserted into lower line of sight visor housing 46 and horizontal line of sight visor housing 47.

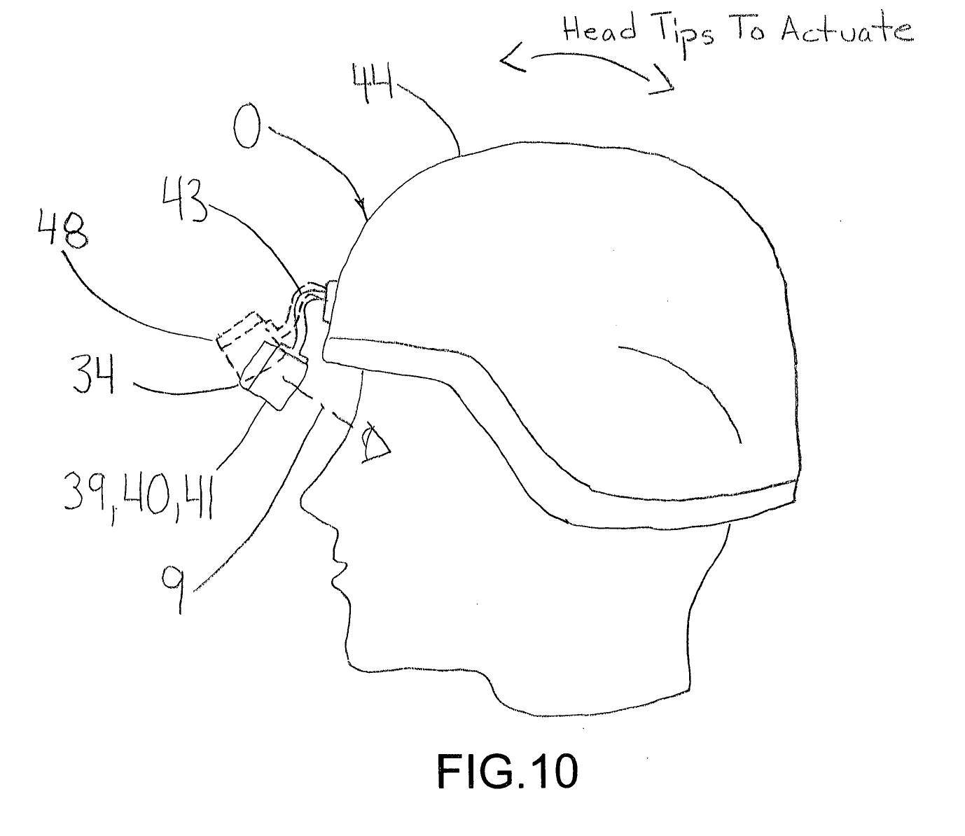

Attachment Arm Repositioning Mechanism—FIGS. 10 & 11

An alternate embodiment provides level sensor actuation mechanism 49 which positions the micro-display in the user's upper line of sight when the user's head is tipped above a predefined angle of 30 degrees and mechanism 49 positions the micro-display in an actuated position 48 when the user's head is tipped below the predefined angle of 30 degrees. This feature provides no micro-display obstruction when the user's head is normally positioned and a view of the micro-display when the user tilts his head above 30 degrees.

### CONCLUSIONS, RAMIFICATIONS, AND SCOPE

Thus the reader will see that mounting a binocular micro-display to a head supported structure such as goggles, a helmet, eyewear, or headband in the user's upper line of sight will allow him the freedom to perform many activities which require a clear view of his external environment, while also providing an optical projection when he simply glances to his upper line of sight. The removable tinted lens inserts allow the display assembly to be used in high ambient light as well as low light levels.

An adjustable forehead rest may also be used to decrease the angular projection of the micro-display. This decreased angle is achieved by pushing the goggles away from the user's forehead and allowing the goggles to pivot slightly at its lower contact area with the user's face. The user may need to slightly adjust the goggles vertically on his face after employing the forehead rest to ensure that the optical projection is positioned nominally normal to his line of sight. The adjustable forehead rest may be comprised of a snap on foam assembly, an air inflatable assembly, a goggle integrated lever, or any other arrangement which changes the angle of the optical projection relative to the user's face.

The goggles may also be designed or modified to allow the user to adjust the optical projection's vertical position relative to the user's face. This adjustment feature provides the user with the ability to slide the display assembly relative to his face to ensure that the optical projection is located nominally normal to his upper line of site. Additionally, this feature may also be used to allow the user to slide the display assembly up (relative to his face) to the extent necessary to move the display housing partially or completely out of his upper line of sight, thus providing an unobstructed upper line of sight when not viewing the micro-display. This adjustment feature may be achieved by reducing or modifying the goggles' nose piece, or by using a vertically adjustable nose piece.

In one option, a window is cut within the goggles' visor to reduce the number of optical surfaces between the micro-display and the user's eyes. This window may be particularly useful if the visor is tinted.

Another option is a wedge insert mount which is placed between the display housing and visor, and used to change the micro-display's angle relative to the visor, thus altering the optical projection angle within the user's upper line of sight.

Multiple sets of binocular micro-displays can be used side by side or a single binocular micro-display set can be shifted to one side of the view.

In one option, the user can change to other head supported structures by simply transferring a removable display module.

The scope of the invention should be determined by the appended claims and their legal equivalents, rather than by the examples given.

I claim:

1. a head mounted display assembly comprising:
a binocular micro-display; a head supported structure;
a mounting interface to attach said micro-display to said head supported structure;
the adjoining geometry of said mounting interface provides a user wearing said assembly:
a nominally normal optical projection in the user's upper line of sight, and
an unobstructed horizontal line of sight.

2. The display assembly of claim 1 wherein said mounting interface is comprised of an enclosure surrounding the exterior of said micro-display; the enclosure is further comprised of a viewing channel to allow unobstructed travel of the optical projection, thereby providing a protective feature surrounding the micro-display while allowing unobstructed travel of the micro-display's optical projection to the user's eyes.

3. The display assembly of claim 2 wherein said head supported structure is further comprised of an attached visor, thereby providing the user with eye protection from his external environment.

4. The display assembly of claim 3 wherein said enclosure is further comprised of a housing profile feature which conforms to the outer profile of said visor, said profile feature attaches said enclosure to said visor, thereby providing an environmental and light encased viewing channel to protect the micro-display's optical lenses.

5. The display assembly of claim 4 wherein said head supported structure is comprised of goggles.

6. The display assembly of claim 5 wherein a forehead spacer is provided to pivot the goggles relative to the user's face, thereby providing a decreased upper line of sight viewing angle.

7. The display assembly of claim 4, wherein said enclosure is further comprised of a left and right lateral clearance flange providing clearance nominally normal to the user's upper left and upper right upper line of sight, thereby eliminating obstruction within the left and right side of the user's upper line of sight caused by the sides of the enclosure.

8. The display assembly of claim 4, wherein said enclosure is further comprised of a bottom flange providing clearance nominally normal to the user's midlevel line of sight, thereby eliminating obstruction within the user's midlevel line of sight caused by the bottom of the enclosure.

9. The display assembly of claim 4, further comprising removable tinted lenses placed between the user's eyes and the outside environment and devoid in the area between user's eyes and said micro-display's optical projection, thereby providing the user with shade from sunlight without reducing the intensity of the micro-display's optical projection.

10. The display assembly of claim 2, wherein said enclosure is further comprised of a housing channel section and a locking cap; said micro-display is attached to said locking cap to form a removable display module; said removable display module attaches to said housing channel section, thereby allowing said micro-display to be used with special purpose housings located on various head supported structures.

11. The display assembly of claim 2, wherein said mounting interface is further comprised of an attachment arm which attaches said enclosure to said head supported structure, thereby positioning the micro-display at a set position from the user's eyes.

12. The display assembly of claim 11, wherein said head supported structure is comprised of a helmet.

13. The display assembly of claim 11, wherein said attachment arm provides the means to reposition its end attached to said enclosure, thereby allowing the micro-display to be repositioned relative to the user's eyes.

14. The display assembly of claim 13, wherein said attachment arm repositioning means is controlled by a level sensor actuation mechanism, whereby the micro-display is positioned in the user's upper line of sight when the user's head is tipped above a predefined angle and said mechanism positions the micro-display in an upper position outside the user's upper line of sight when the user's head is tipped below said predefined angle.
